(19) United States
(12) Patent Application Publication
(10) Pub. No.: US 2025/0214717 A1
(43) Pub. Date: Jul. 3, 2025

(54) METHODS AND ASSEMBLIES FOR GROUND VIBRATIONAL TESTING

(71) Applicant: Gulfstream Aerospace Corporation, Savannah, GA (US)

(72) Inventors: Andrew Merk, Savannah, GA (US); Jason Rankine, Savannah, GA (US); Mike Murphy, Savannah, GA (US); Robert LeBlanc, Savannah, GA (US)

(73) Assignee: Gulfstream Aerospace Corporation, Savannah, GA (US)

(21) Appl. No.: 18/397,241

(22) Filed: Dec. 27, 2023

(51) Int. Cl. B64F 5/60; G01M 7/02

(52) U.S. Cl. CPC B64F 5/60; G01M 7/027

(57) ABSTRACT

Methods and assemblies for performing ground vibration testing are provided. A method for supporting a vehicle for ground vibration testing includes lifting the vehicle from a ground surface; locating a nose support fixture under the vehicle nose, wherein the nose support fixture comprises an A-frame formed from aft and second rafter structures; an overhead crossbar configured for removable attachment to the tops of the rafter structures, wherein an internal space is defined between the rafter structures; and an extension member received within the internal space; mounting the extension member to a nose landing gear axle; removing the overhead crossbar from the tops of the of the rafter structures; encircling the overhead crossbar and the extension member with a desired number of elastic bands; connecting the overhead crossbar to the tops of the of the rafter structures; and lowering the vehicle to allow the elastic bands to support the vehicle.

### TECHNICAL FIELD

The technical field relates generally to ground vibration testing, and more particularly relates to the fixtures that support a vehicle during ground vibration testing and to methods for supporting the vehicle during testing.

### BACKGROUND

Ground vibration testing of a vehicle, such as an aircraft, is performed to determine the vibration characteristics of the vehicle, such as to confirm that an aircraft is free from flutter under normal operating conditions. During ground vibration testing, electro-dynamic shakers may be coupled to the vehicle to provide an excitation input (e.g., vibration) to the vehicle. The dynamic response of the vehicle to the excitation input may be measured using sensors (e.g., accelerometers) mounted at various locations on the vehicle. The dynamic response may be compared to a structural dynamic analysis of the vehicle for determining the frequency and damping characteristics of the vehicle. The results of the comparison may be used to validate and/or refine the structural dynamic analysis model.

To simulate a vehicle in flight, the vehicle must be supported for “free-free” analysis, which indicates that the vehicle is free of load and free of boundary conditions. Further, the vehicle should be supported such that it is free to have rigid movement in six degrees of freedom in three-dimensional space. Testing is generally performed on the vehicle for at least two weights, the weight of the vehicle without fuel and the weight of the vehicle with full fuel tanks.

In conventional practices, the vehicle is lifted and supported at the vehicle's landing gear. Typically, the process of achieving a free-free condition is time consuming and arduous. Further, changing the weight of the vehicle mid-test often requires a full tear down and resetting of the support equipment.

Accordingly, it is desirable to provide ground vibration testing assemblies that address one or more of the foregoing issues, and methods for supporting vehicle for ground vibration testing. Furthermore, other desirable features and characteristics of the various embodiments described herein will become apparent from the subsequent detailed description and the appended claims, taken in conjunction with the accompanying drawings and this background.

### SUMMARY

Various non-limiting embodiments of a vehicle, an environmental control system for a vehicle having an interior, and a method for operating an environmental control system for a vehicle are provided herein.

In a first non-limiting embodiment, a method for supporting a vehicle for ground vibration testing includes lifting the vehicle from a ground surface and locating a nose support fixture under a nose of the vehicle, wherein the nose support fixture includes an A-frame formed from a first rafter structure extending from a bottom to a top; a second rafter structure extending from a bottom to a top; an overhead crossbar configured for removable attachment to the tops of the rafter structures, wherein an internal space is defined between the rafter structures; and an extension member received within the internal space. The method further includes mounting the extension member to a landing gear axle on the nose of the vehicle; removing the overhead crossbar from the tops of the of the rafter structures; encircling the overhead crossbar and the extension member with a desired number of elastic bands; connecting the overhead crossbar to the tops of the of the rafter structures; and lowering the vehicle to allow the elastic bands to support the vehicle.

In another non-limiting embodiment, a method for performing ground vibration testing on different models of vehicles includes providing a universal nose support fixture configured to support a nose landing gear axle of each vehicle; providing a plurality of mounting component pairs, wherein each mounting component pair is dedicated for mounting to a main landing gear axle of a respective model of vehicle; providing a universal main landing gear support fixture configured for connection to each mounting component pair in the plurality of mounting component pairs; lifting a selected vehicle from a ground surface; connecting the universal nose support fixture to the nose landing gear axle of the selected vehicle; mounting a selected mounting component pair from the plurality of mounting component pairs to the main landing gear axle of the selected vehicle; connecting the universal main landing gear support fixture to the selected mounting component pair; and supporting the vehicle with nose elastic bands engaging the universal nose support fixture and main elastic bands engaging the universal main landing gear support fixture.

In another non-limiting embodiment, the vehicle includes, but is not limited to, an assembly for performing ground vibration testing on different models of vehicle is provided. The assembly includes a universal nose support fixture configured to support a nose landing gear axle of each vehicle, wherein the universal nose support fixture comprises an overhead crossbar configured to maintain a static position during testing and an extension member configured for movement relative to the overhead crossbar; nose elastic bands engaged between the overhead crossbar and the extension member; a plurality of mounting component pairs, wherein each mounting component pair is dedicated for mounting to a main landing gear axle of a respective model of vehicle; a universal main landing gear support fixture configured for connection to each mounting component pair in the plurality of mounting component pairs, wherein the universal main landing gear support fixture comprises a pair of upper bars configured to maintain a static position during testing and a pair of lower bars configured for movement relative to the upper bars; and main elastic bands engaged between respective upper bars and lower bars.

### BRIEF DESCRIPTION OF THE DRAWINGS

The various embodiments will hereinafter be described in conjunction with the following drawing figures, wherein like numerals denote like elements, and wherein:

FIG. 1 is a simplified schematic view illustrating a vehicle supported by fixtures for performance of ground vibrational testing in accordance with an exemplary embodiment;

FIG. 2 is a perspective schematic view of a nose landing gear axle connected to a portion of a universal nose support fixture in accordance with an exemplary embodiment;

FIG. 3 is a perspective schematic view of a nose landing gear axle connected to a universal nose support fixture in accordance with an exemplary embodiment;

FIG. 4 is a front schematic view of a nose landing gear axle connected to a universal nose support fixture in accordance with an exemplary embodiment;

FIG. 5 is a perspective schematic view of a main landing gear axle;

FIG. 6 is a perspective schematic view of the main landing gear axle of FIG. 5 connected to a pair of mounting components in accordance with an exemplary embodiment;

FIG. 7 is a perspective schematic view of a main landing gear axle connected to a portion of a universal main landing gear support fixture in accordance with an exemplary embodiment;

FIG. 8 is a front cross-sectional schematic view of a main landing gear axle connected to a portion of a universal main landing gear support fixture in accordance with an exemplary embodiment;

FIG. 9 is a perspective schematic view of a shaker support structure holding an electro-dynamic shaker in accordance with an exemplary embodiment; and

FIG. 10 is a perspective schematic view of an electro-dynamic shaker connected to a structural block in mating engagement with an external surface location of the vehicle in accordance with an exemplary embodiment.

### DETAILED DESCRIPTION

The following Detailed Description is merely exemplary in nature and is not intended to limit the various embodiments or the application and uses thereof. Furthermore, there is no intention to be bound by any theory presented in the preceding background or the following detailed description.

The exemplary embodiments taught herein are for use with vehicles, for example, an aircraft or the like. Each vehicle includes a landing gear, such as a nose landing gear at the nose of the vehicle and two main landing gear behind the center of gravity of the vehicle. Different models of vehicle may have different structural arrangements of nose landing gear and/or of main landing gear. In some embodiments, a nose landing gear structure is shared with a plurality of vehicles, while the main landing gear structure differs between vehicles.

Exemplary embodiments herein provide an assembly for performing ground vibration testing on different models of vehicle despite structural differences. Thus, the assembly may include a universal nose support fixture configured to support a nose landing gear axle of each vehicle. Also, the assembly may include a plurality of mounting components or mounting component pairs. Each mounting component pair may be dedicated for mounting to a main landing gear axle of a respective model of vehicle. Further, each mounting component pair is provided with a universal connection structure. Accordingly, the assembly may include a universal main landing gear support fixture configured for connection to the universal connection structure of each mounting component pair in the plurality of mounting component pairs.

In addition, exemplary embodiments of universal nose support fixtures include an overhead crossbar configured to maintain a static position during testing and an extension member configured for movement relative to the overhead crossbar. Elastic bands engage the extension member to the overhead crossbar. The overhead crossbar is supported by an A-frame during testing, but is configured for easy disconnection from the A-frame in order to add or subtract the number of elastic bands interconnecting the extension member and the overhead crossbar.

Exemplary embodiments of the universal main landing gear support fixtures include a pair of upper bars configured to maintain a static position during testing and a pair of lower bars configured for movement relative to the upper bars. Elastic bands each extension member to a respective overhead crossbar. Each upper bar is supported by rafter structures and is configured to be disconnected at one end to allow for addition or subtraction of elastic bands interconnecting each lower bar to the respective upper bar.

Also, exemplary embodiments of the universal nose support fixtures and the universal main landing gear support fixtures include structural designs to allow for easy transport, such as by forklift trucks, and for vertical height adjustment.

FIG. 1 illustrates a schematic view of a vehicle 100 supported over a ground surface 101 by a ground vibration testing assembly 200 for vibration testing. The vehicle 100 may be an aircraft having nose landing gear 110 and a pair of a main landing gear 120. The ground vibration testing assembly 200 includes a universal nose support fixture 300 and a pair of universal main landing gear support fixtures 400 (only one universal main landing gear support fixture 400 is visible in FIG. 1). Further, the ground vibration testing assembly 200 may include a shaker support structure 500 to position and support an electro-dynamic shaker 600 that provides an excitation input to the vehicle 100.

While a single pair of shaker support structure 500 and single electro-dynamic shaker 600 are illustrated, there may be many such pairs provided at locations including the horizontal stabilizer, wings, and engine.

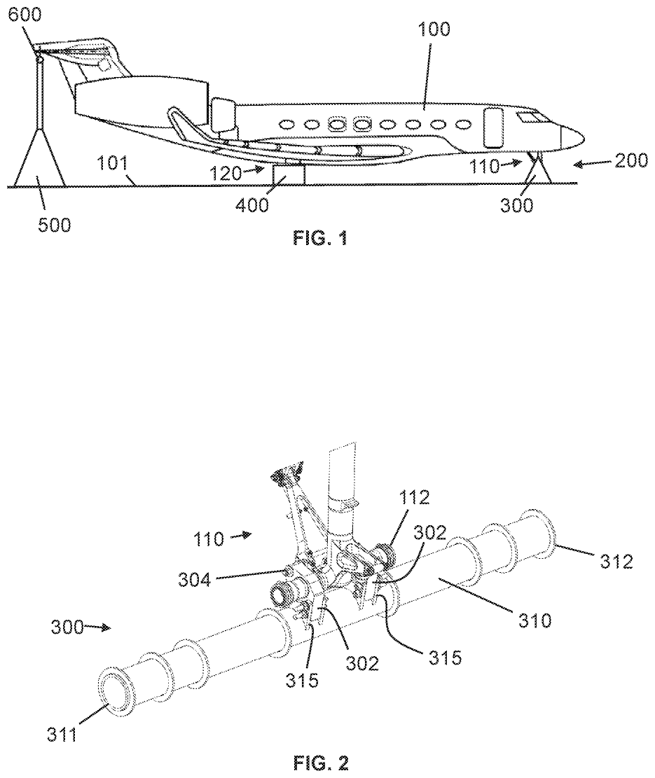

FIG. 2 is a perspective schematic view of the connection between the nose landing gear 110 of the vehicle 100 and a portion of the universal nose support fixture 300.

As shown, the wheels and other components are removed from the nose gear axle 112 of the nose landing gear 110 so that the nose landing gear 110 may be supported by the universal nose support fixture 300. The universal nose support fixture 300 includes a pair of axle mounts 302 that are formed with bores to receive the nose gear axle 112. Thus, the axle mounts 302 may slide onto the nose gear axle 112, and each axle mount 302 may be secured to the nose gear axle 112 by connecting a pin 304 to an existing attachment point located on the nose landing gear 110.

After fixing the axle mounts 302 to the nose landing gear 110, an extension member 310 is fixed to the axle mounts 302. Specifically, the extension member 301 may include brackets 315 that extend perpendicular to the axis of the extension member 301, and the brackets 315 are fixed to the axle mounts 302. For example, the axle mounts 302 and the brackets 315 may be formed with holes that are aligned so that engagement features such as bolts may pass through the holes to fix the extension member 310 to the axle mounts 302.

An exemplary extension member 310 is a tube, such as an axle tube weldment, and extends from a first end 311 to a second end 312. The extension member 310 may be a rod, bar or other suitable structural shape.

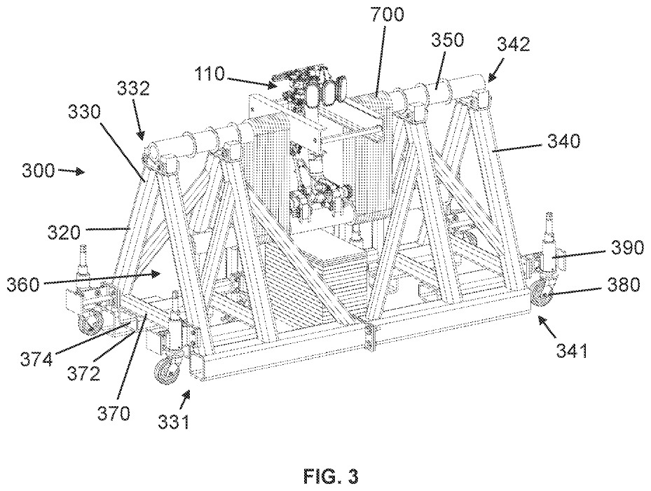

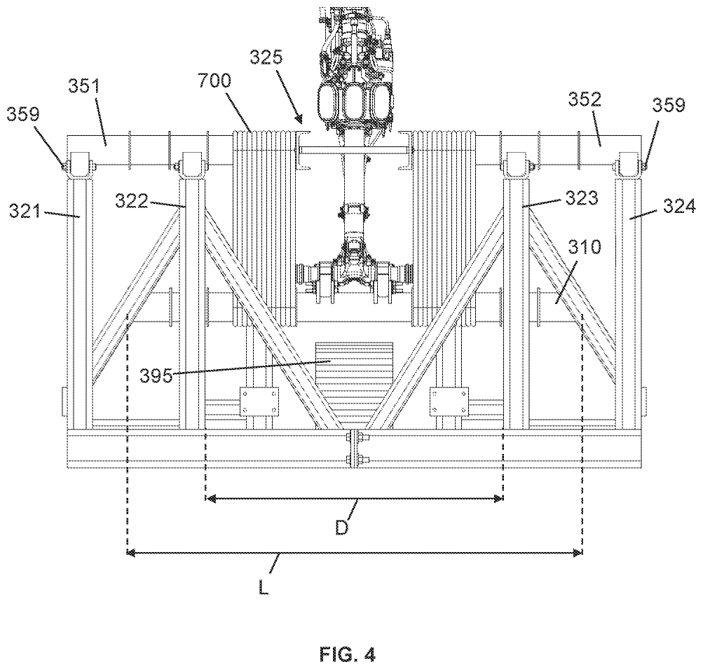

FIG. 3 is a perspective schematic view of the universal nose support fixture 300 while supporting the nose landing gear 110 of the vehicle 100. FIG. 4 is a front schematic view of the universal nose support fixture 300 while supporting the nose landing gear 110 of the vehicle 100.

Cross-referencing FIGS. 3 and 4, it may be seen that the universal nose support fixture 300 further includes an A-frame 320.

The A-frame 320 is formed from a first (or aft) rafter structure 330 extending from a bottom 331 to a top 332, and a second (or fore) rafter structure 340 extending from a bottom 341 to a top 342. Each rafter structure 330 and 340 may be formed interconnected beams or tubes, such as steel beams or tubes, as shown.

The A-frame 320 further includes an overhead crossbar 350 configured for removable attachment to the tops 332 and 342 of the rafter structures 330 and 340. As shown, an internal space 360 is defined between the rafter structures 330 and 340.

As shown most clearly in FIG. 3, the extension member 310 is received within the internal space 360.

The extension member 310 and the overhead crossbar 350 are encircled by a desired number of elastic bands 700, such as bungees. Thus, the universal nose support fixture 300 provides support of the vehicle 100 through connection of the nose gear axle 112 to axle mounts 302, axle mounts 302 to extension member 310, and extension member 310 to overhead crossbar 350 via the elastic bands 700.

As shown, the A-frame 320 includes a bottom structure 370 interconnecting the bottom 331 of the first rafter structure 330 and the bottom 341 of the second rafter structure 340. The bottom structure 370 may be formed from interconnected beams or tubes, such as steel beams or tubes, as shown.

In the illustrated embodiment, the bottom structure 370 includes tubes 372 defining channels 374. As shown, the tubes 372 and channels 374 are parallel to the nose gear axle 112. The channels 374 are configured to receive the forks of a forklift truck, and the tubes 372 are provided with sufficient strength such that the forklift truck may insert the forks into the channels 374 and lift and carry the universal nose support fixture 300 to a location under the nose of the vehicle for supporting the vehicle.

As shown in FIG. 3, the A-frame 320 includes wheels 380 configured to roll on the ground surface 101. As further shown, the A-frame 320 includes vertical height adjustment mechanisms 390 interconnecting the wheels 380 to the rafter structures 330 and 340. The vertical height adjustment mechanisms 390 may be operated to adjust the height of the A-frame 320. The vertical height adjustment mechanisms 390 may include jacks or leveling casters.

FIGS. 3 and 4 illustrate that each rafter structure 330 and 340 includes a port terminal leg 321, a port intermediate leg 322, a starboard intermediate leg 323, and a starboard terminal leg 324. The overhead crossbar 350 may be supported by the top of each leg 321-324 of the rafter structures 330 and 340. Thus, the overhead crossbar 350 includes a port section 351, in contact with legs 321 and 322, and a starboard section 352, in contact with legs 323 and 324. A lateral gap 325 is defined between the port section 351 and the starboard section 352. As shown in FIG. 3, the nose landing gear 110 may extend vertically downward through the gap 325.

As shown in FIG. 4, the port intermediate leg 322 and the starboard intermediate leg 323 are separated by a lateral distance D. Further, the extension member 310 has a lateral length L, from end 311 to end 312, that is greater than the lateral distance D.

In certain embodiments, elastic bands 700 encircle the overhead crossbar 350 and the extension member 310 at locations between the port terminal leg 321 and the port intermediate leg 322, between the port intermediate leg 322 and the gap 325, between the gap 325 and the starboard intermediate leg 323, and between the starboard intermediate leg 323 and the starboard terminal leg 324.

In exemplary embodiments, the overhead crossbar 350 is easily disconnected from and reconnected to the rafter structures 330 and 340. For example, an interconnect structure 359 between the overhead crossbar 350 and each rafter structure 330 and 340 may include a bore and bolt connection. Therefore, elastic bands 700 may be added to increase the total retractive spring force of the plurality of elastic bands 700 encircling the overhead crossbar 350 and the extension member 310. Likewise, elastic bands 700 may be subtracted to decrease the retractive spring force of the total retractive spring force of the plurality of elastic bands 700 encircling the overhead crossbar 350 and the extension member 310.

Further, it is contemplated that the number of elastic bands encircling the overhead crossbar 350 and the extension member 310 may be changed without removing the universal nose support fixture 300 from the vehicle 100. Specifically, surplus elastic bands 700 may be located around the overhead crossbar 350 and/or around a leg, such as terminal leg 321 or 324, but not encircling the extension member 310. Then the entire vehicle 100 is raised at jacking points to lift the extension member 310 with respect to the overhead cross bar 350 to allow elastic bands 700 to be slipped onto the extension member 310 from the surplus location or off of the extension member. Then, the vehicle is lowered and supported by the extension member 310 and elastic bands 700.

It is noted that an adjustable safety platform 395 may be provided under the extension member 310. For example, the adjustable safety platform 395 may be a stack of individual boards. The adjustable safety platform 395 may be provided to catch the extension member 310 in case of an accidental failure of the universal nose support fixture 300.

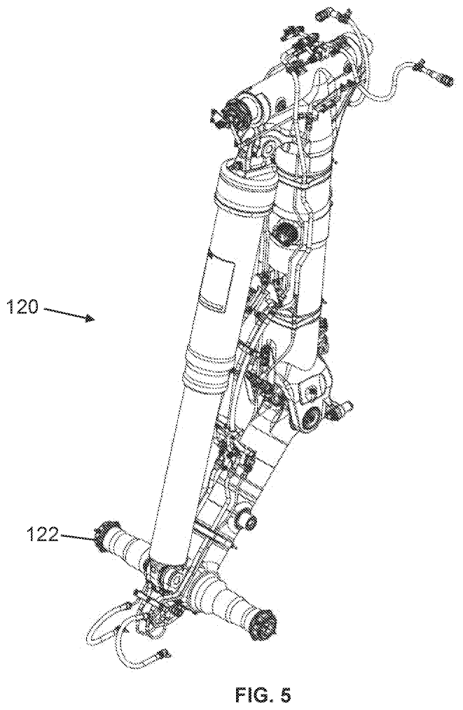

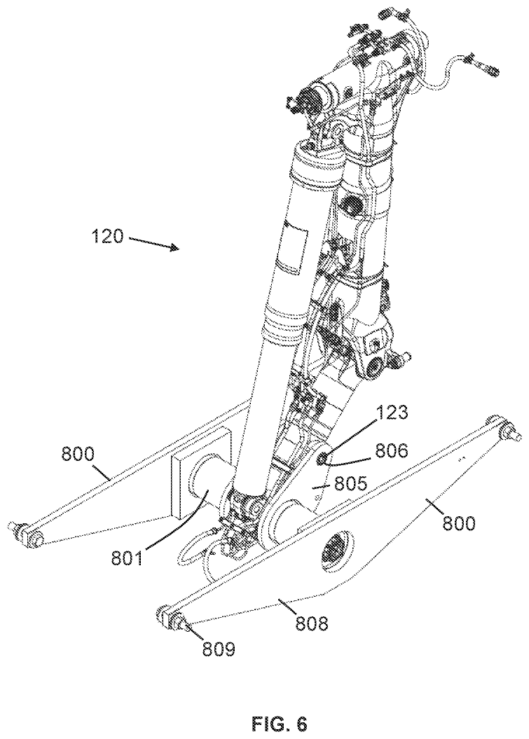

Referring now to FIGS. 5-6, connection of a mounting component pair to a vehicle 100 is described. As shown in FIG. 5, the wheels and other components are removed from the main landing gear axle 122 of the main landing gear 120 so that the main landing gear 120 may be supported by a universal main landing gear support fixture.

In FIG. 6, a pair of mounting components 800 is fixed to the main landing gear axle 122 of the main landing gear 120. For example, the mounting components 800, which may be mirror images of one another, each include a sleeve portion 801 formed with a bore to receive the main landing gear axle 122. Further, each mounting component 800 includes a flange 805 at a proximal end of the sleeve portion 801. Also, each flange 805 may be formed with an opening 806. Thus, the sleeve portions 801 of the mounting components 800 may slide onto the main landing gear axle 122, and each mounting component 800 may be secured to the main landing gear axle 122 by passing a member 123 on the main landing gear 120 through the opening 806 in the flange 805. Member 123 may be a cylindrical feature of the body of the landing gear strut. Each mounting component 800 slides on the axle and then is rotated until the flange 805 slides on to the feature 123 to maintain the proper orientation. Lastly, the axle nut is installed to prevent the mounting component 800 from moving along the axis of the axle.

As further shown, each mounting component 800 includes a plate portion 808 that is substantially perpendicular to the sleeve portion 801. The plate portion 808 may be formed with connection features 809 at opposite ends.

It is noted that the structural designs of the main landing gear on different vehicles may differ. Therefore, a pair of mounting components 800 may be designed for connection to a specific vehicle model. Specifically, the sleeve portion 801, flange 805, and openings 806 may be designed for interconnection with a specific vehicle model. However, among a plurality of mounting components 800 provided for connection with the main landing gear of different vehicle models, each mounting components 800 is formed with a universal connection to a universal main landing gear support fixture. For example, the connection features 809 may be provided at the same relative location with respect to the main landing gear axle 122.

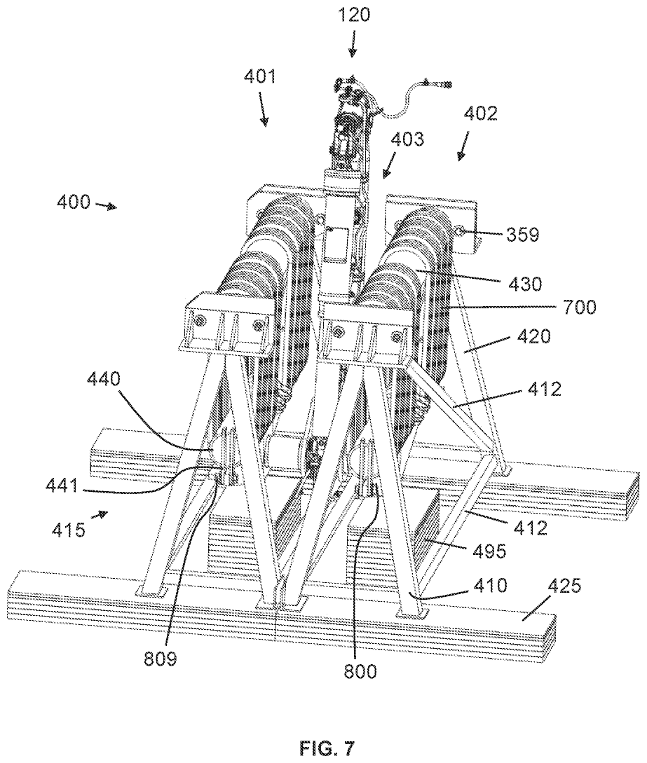

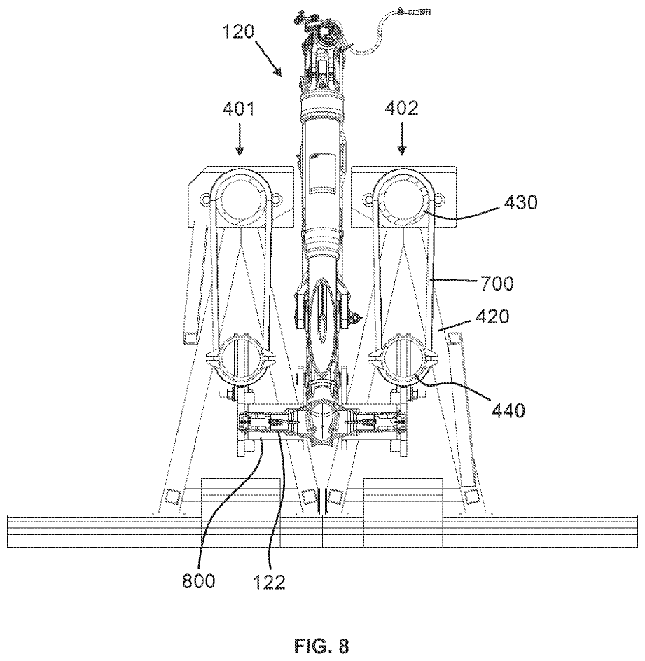

FIGS. 7-8 illustrate an exemplary universal main landing gear support fixture 400, shown connected to a pair of mounting components 800 on the main landing gear axle 122 of the main landing gear 120.

As shown in FIGS. 7-8, the universal main landing gear support fixture 400 includes a pair of main support structures 401 and 402. The main support structures 401 and 402 may be spaced apart from one another by a gap 403 which receives the main landing gear 120.

Each main support structure 401 and 402 includes a first or aft A-frame support 410 and a second or fore A-frame support 420. Cross beams 412 interconnect the first A-frame support 410 and the second A-frame support 420. The first A-frame support 410, the second A-frame support 420, and the cross beams 412 may be formed from beams or tubes, such as steel beams or tubes. An internal space 415 of each main support structure 401 and 402 is defined between the A-frame supports 410 and 420.

Further, each main support structure 401 and 402 includes an upper bar 430 interconnecting the first A-frame support 410 and the second A-frame support 420. Also, each main support structure 401 and 402 includes a lower bar 440 received in the internal space 415. As shown, each lower bar 440 is fixed to a respective mounting component 800. Specifically, each lower bar 440 is formed with a connection flange 441 that may provide mating engagement with the connection features 809 of the mounting component 800. For example, a pin or bolt may pass through aligned bores of the connection flange 441 and the connection features 809.

Within each main support structure 401 and 402, the lower bar 440 and the upper bar 430 are encircled by a desired number of elastic bands 700. Thus, the universal main landing gear support fixture 400 provides support of the vehicle 100 through connection of the main landing gear axle 122 to mounting components 800, mounting components 800 to lower bar 440, and lower bar 440 to upper bar 430 via the elastic bands 700.

In exemplary embodiments, the upper bar 430 is easily disconnected from and reconnected to at least one of the A-frame supports 410 or 420. For example, an interconnect structure 359 between the upper bar 430 and at least one of the A-frame supports 410 or 420 may include a bore and bolt connection. Therefore, elastic bands 700 may be added to increase the total retractive spring force of the plurality of elastic bands 700 encircling the upper bar 430 and the lower bar 440. Likewise, elastic bands 700 may be subtracted to decrease the retractive spring force of the total retractive spring force of the plurality of elastic bands 700 encircling the upper bar 430 and the lower bar 440.

Further, it is contemplated that the number of elastic bands encircling the upper bar 430 and the lower bar 440 may be changed while the vehicle 100 is temporarily supported to allow modifications to the universal main landing gear support fixture 400. For example, the entire vehicle 100 may be lifted at the jacking points until all elastic bands 700 are loose. A ratchet strap or other suitable device may be used to lift the lower bar 440 with respect to the upper bar 430 to allow elastic bands 700 to be slipped onto the lower bar 440 or off of the lower bar 440. For example, surplus elastic bands 700 may be located around an A-frame support 410 or 420. When the upper bar 430 is disconnected from the A-frame support 420 a desired number of elastic bands 700 may be positioned around the lower bar 440 and upper bar 430. Then, the ratchet strap may be released and the vehicle 100 may be lowered. It is noted that the aircraft 100 should be supported at level or nose down during such a modification for safety purposes.

It is noted that an adjustable safety platform 495 may be provided under the lower bar 440. For example, the adjustable safety platform 495 may be a stack of individual boards. The adjustable safety platform 495 may be provided to catch the lower bar 440 in case of an accidental failure of the universal main landing gear support fixtures 400.

Further, the A-frame supports 410 and 420 may be mounted on an adjustable platform 425. For example, the adjustable platform 425 may be a stack of individual boards. The height of the A-frame supports 410 and 420 may be adjusted by adding or removing boards from the adjustable platform 425.

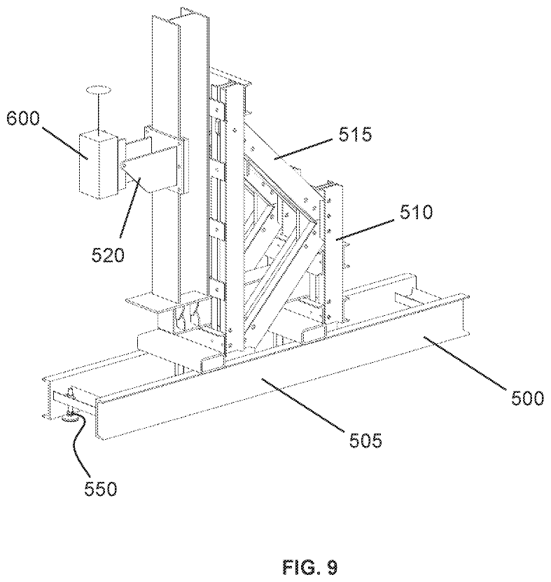

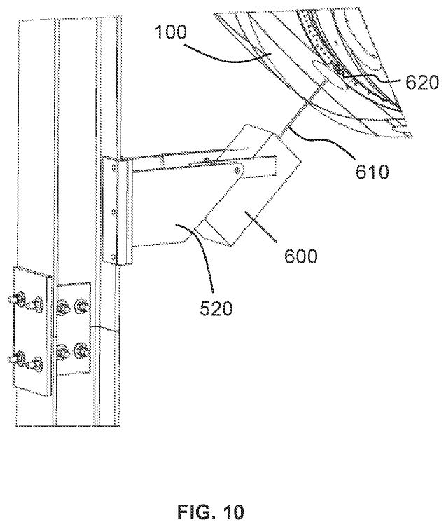

Referring now to FIGS. 9-10, an embodiment of the shaker support structure 500 and electro-dynamic shaker 600 are illustrated. The shaker support structure 500 include a lateral ground beam 505, vertical beams 510, and support beams 515 that cooperate to hold a shaker mount 520 at a desired height and at a desired angle. The beams may be steel. Thus, the electro-dynamic shaker 600 may be held securely in position by the shaker mount 520 while providing an excitation input to the vehicle 100. The shaker support structure 500 is provided with a leveling mechanism 550. For example, the leveling mechanism 550 may be a leveling foot or feet or may include manual shimming. As a result, the shaker support structure 500 may be installed such that the ground beam 505 is stable even on uneven surfaces. Thus, the shaker support structure 500 will not rock or otherwise move in relation to the ground surface. When installed properly, the shaker support structure 500 is a stable and stationary structure that allows all vibrations from the electro-dynamic shaker 600 to be transmitted to the vehicle 100.

In FIG. 10, the electro-dynamic shaker 600 is shown applying an excitation input to the vehicle 100. Specifically, a stinger 610 is mechanically connected to the electro-dynamic shaker 600 and to a structural block 620. The structural block 620 may be designed for mating engagement with the external surface location of the vehicle 100. The structural block 620 may be formed by three-dimensional printing. Further, the structural block 620 may be adhered to the external surface location of the vehicle 100. In this manner, the excitation input to the vehicle 100 may be applied to the structural block 620 to avoid damaging the exterior surface of the vehicle 100.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It being understood that various changes may be made in the function and arrangement of elements described in an exemplary embodiment without departing from the scope of the disclosure as set forth in the appended claims.

What is claimed is:

1. A method for supporting a vehicle for ground vibration testing, comprising:
lifting the vehicle from a ground surface;
locating a nose support fixture under a nose of the vehicle, wherein the nose support fixture comprises:
an A-frame comprising:
a first rafter structure extending from a bottom to a top;
a second rafter structure extending from a bottom to a top;
an overhead crossbar configured for removable attachment to the tops of the rafter structures, wherein an internal space is defined between the rafter structures; and
an extension member received within the internal space;
mounting the extension member to a landing gear axle on the nose of the vehicle;
removing the overhead crossbar from the tops of the of the rafter structures;
encircling the overhead crossbar and the extension member with a desired number of elastic bands;
connecting the overhead crossbar to the tops of the of the rafter structures; and
lowering the vehicle to allow the elastic bands to support the vehicle.

2. The method of claim 1, wherein:
the A-frame includes a bottom structure interconnecting the bottom of the first rafter structure and the bottom of the second rafter structure;
the bottom structure includes tubes defining channels; and
locating the nose support fixture under the nose of the vehicle comprises inserting forks of a forklift truck into the channels, lifting the A-frame, and carrying the A-frame to a location under the nose of the vehicle.

3. The method of claim 1, wherein the A-frame further comprises:
wheels configured to roll on the ground surface; and
vertical height adjustment mechanisms interconnecting the wheels to the rafter structures.

4. The method of claim 1, further comprising adjusting a height of the A-frame with the vertical height adjustment mechanisms.

5. The method of claim 1, wherein:
each rafter structure comprises a port terminal leg, a port intermediate leg, a starboard terminal leg, and a starboard intermediate leg;
the overhead crossbar comprises a port section and a starboard section, wherein a gap is defined between the port section and the starboard section; and
encircling the overhead crossbar and the extension member with the desired number of elastic bands comprises:
locating elastic bands between the port terminal leg and the port intermediate leg;
locating elastic bands between the port intermediate leg and the gap;
locating elastic bands between the starboard terminal leg and the starboard intermediate leg; and
locating elastic bands between the starboard intermediate leg and the gap.

6. The method of claim 1, wherein
the nose support fixture comprises axle mounts; and
mounting the extension member to the landing gear axle comprises:
sliding each axle mount onto the landing gear axle; and
connecting each axle mount to the extension member.

7. The method of claim 1, further comprising:
locating a main support fixture under a main landing gear of the vehicle, wherein the main support fixture comprises:
a pair of main support structures, wherein each main support structure comprises:
a first A-frame support;
a second A-frame support;
an upper bar interconnecting the first A-frame support and the second A-frame support;
a sleeve; and
a lower bar;
mounting each sleeve on an axle of the main landing gear;
connecting each sleeve to a respective lower bar; and
encircling each upper bar and a respective lower bar with main elastic bands, wherein the main elastic bands support the vehicle when the vehicle is lowered.

8. The method of claim 7, further comprising adjusting of number of main elastic bands encircling each upper bar and respective lower bar by:
disconnecting the upper bar from a selected A-frame support; and
moving selected main elastic bands into or out of engagement with the respective upper bar.

9. The method of claim 7, wherein:
each main support structure further comprises a mounting component; and
connecting each sleeve to a respective lower bar comprises:
connecting each sleeve to a respective mounting component; and
connecting each mounting component to a respective lower bar.

10. The method of claim 1, further comprising:
forming a structural block for mating engagement with an external surface location of the vehicle;
adhering the structural block to the external surface location of the vehicle; and
coupling an electro-dynamic shaker to the structural block to provide an excitation input to the vehicle.

11. A method for performing ground vibration testing on different models of vehicle, the method comprising:
providing a universal nose support fixture configured to support a nose landing gear axle of each vehicle;
providing a plurality of mounting component pairs, wherein each mounting component pair is dedicated for mounting to a main landing gear axle of a respective model of vehicle;
providing a universal main landing gear support fixture configured for connection to each mounting component pair in the plurality of mounting component pairs;
lifting a selected vehicle from a ground surface;
connecting the universal nose support fixture to the nose landing gear axle of the selected vehicle;
mounting a selected mounting component pair from the plurality of mounting component pairs to the main landing gear axle of the selected vehicle;
connecting the universal main landing gear support fixture to the selected mounting component pair; and
supporting the vehicle with nose elastic bands engaging the universal nose support fixture and main elastic bands engaging the universal main landing gear support fixture.

12. The method of claim 11, wherein the universal nose support fixture comprises
an A-frame comprising:
a first rafter structure extending from a bottom to a top;
a second rafter structure extending from a bottom to a top;
an overhead crossbar configured for removable attachment to the tops of the rafter structures, wherein an internal space is defined between the rafter structures; and
an extension member received within the internal space;
wherein connecting the universal nose support fixture to the nose landing gear axle of the selected vehicle comprises:
mounting the extension member to the nose landing gear axle; and
encircling the overhead crossbar and the extension member with a desired number of the nose elastic bands.

13. The method of claim 12, wherein:
the A-frame includes a bottom structure interconnecting the bottom of the first rafter structure and the bottom of the second rafter structure;
the bottom structure includes tubes defining channels; and
the method further comprises inserting forks of a forklift truck into the channels, lifting the A-frame, and carrying the A-frame to a location under the nose landing gear axle.

14. The method of claim 12, wherein:
each rafter structure comprises a port terminal leg, a port intermediate leg, a starboard terminal leg, and a starboard intermediate leg;
the overhead crossbar comprises a port section and a starboard section, wherein a gap is defined between the port section and the starboard section; and
encircling the overhead crossbar and the extension member with the desired number of the nose elastic bands comprises:
locating nose elastic bands between the port terminal leg and the port intermediate leg;
locating nose elastic bands between the port intermediate leg and the gap;
locating nose elastic bands between the starboard terminal leg and the starboard intermediate leg; and
locating nose elastic bands between the starboard intermediate leg and the gap.

15. The method of claim 11, wherein:
the selected mounting component pair comprises a starboard mounting component and a port mounting component;
the universal main landing gear support fixture comprises a pair of main support structures including a starboard main support structure and a port main support structure,
each main support structure comprises:
a first A-frame support;
a second A-frame support;
an upper bar interconnecting the first A-frame support and the second A-frame support; and
a lower bar; and
connecting the universal main landing gear support fixture to the selected mounting component pair comprises:
connecting the starboard mounting component to the lower bar of the starboard main support structure;
connecting the port mounting component to the lower bar of the port main support structure; and
encircling the upper bar and the lower bar of each main support structure with a desired number of the main elastic bands.

16. An assembly for performing ground vibration testing on different models of vehicle, the assembly comprising:
a universal nose support fixture configured to support a nose landing gear axle of each vehicle, wherein the universal nose support fixture comprises an overhead crossbar configured to maintain a static position during testing and an extension member configured for movement relative to the overhead crossbar;
nose elastic bands engaged between the overhead crossbar and the extension member;
a plurality of mounting component pairs, wherein each mounting component pair is dedicated for mounting to a main landing gear axle of a respective model of vehicle;
a universal main landing gear support fixture configured for connection to each mounting component pair in the plurality of mounting component pairs, wherein the universal main landing gear support fixture comprises a pair of upper bars configured to maintain a static position during testing and a pair of lower bars configured for movement relative to the upper bars; and
main elastic bands engaged between respective upper bars and lower bars.

17. The assembly of claim 16, wherein the universal nose support fixture comprises an A-frame comprising:
a first rafter structure extending from a bottom to a top; and
a second rafter structure extending from a bottom to a top;
wherein the overhead crossbar is configured for removable attachment to the tops of the rafter structures;
wherein an internal space is defined between the rafter structures; and
wherein the extension member received within the internal space.

18. The assembly of claim 17, wherein
the A-frame includes a bottom structure interconnecting the bottom of the first rafter structure and the bottom of the second rafter structure; and
the bottom structure includes tubes defining channels configured to receive forks of a forklift truck.

19. The assembly of claim 17, wherein
each rafter structure comprises a port terminal leg, a port intermediate leg, a starboard terminal leg, and a starboard intermediate leg;
the overhead crossbar comprises a port section and a starboard section, wherein a gap is defined between the port section and the starboard section;
a first group of the nose elastic bands are located between the port terminal leg and the port intermediate leg;
a second group of the nose elastic bands are located between the port intermediate leg and the gap;
a third group of the nose elastic bands are located between the starboard terminal leg and the starboard intermediate leg; and
a fourth group of the nose elastic bands are located between the starboard intermediate leg and the gap.

20. The assembly of claim 16, wherein:
each mounting component pair comprises a starboard mounting component and a port mounting component;
the universal main landing gear support fixture comprises a pair of main support structures including a starboard main support structure and a port main support structure, wherein each main support structure comprises:
a first A-frame support; and
a second A-frame support;
wherein a respective upper bar interconnects the first A-frame support and the second A-frame support;
wherein each upper bar is configured for disconnection from a selected A-frame support; and
wherein a respective lower bar is located between the first A-frame support and the second A-frame support.
